(19) United States
(12) Patent Application Publication
(10) Pub. No.: US 2013/0213828 A1
(43) Pub. Date: Aug. 22, 2013

(54) DESICCANT CONTAINER

(71) Applicants: Abhijit Chatterjee, Pune (IN); Ramesh Rajendra Shetty, Pune (IN)

(72) Inventors: Abhijit Chatterjee, Pune (IN); Ramesh Rajendra Shetty, Pune (IN)

(73) Assignee: LUPIN LIMITED, Mumbai, Maharashtra (IN)

(21) Appl. No.: 13/878,576

(22) PCT Filed: Oct. 1, 2011
(86) PCT No.: PCT/IB11/02309

§ 371 Date: Apr. 10, 2013

(30) Foreign Application Priority Data
Oct. 12, 2010 (IN) 1137/KOL/2010

(51) Int. Cl. A61J 1/03

(52) U.S. Cl. CPC A61J 1/03
USPC 206/204

(57) ABSTRACT

The present application relates to a container for storing tablets and/or capsules. The container may include an upper portion and a bottom portion which defines an integrated chamber, rib profile and a separator means snap-locked in the rib profile. The separator means may include perforated disc means.

### FIELD OF INVENTION

The present invention relates to container for packing capsules and tablets of pharmaceutical nature. More particularly the present invention relates to a container comprising an integrated chamber containing desiccant material(s) separated by a perforated disc thereby eliminating any possibility of the content coming in direct contact with desiccant materials and maintain a moisture free atmosphere inside the container. At the same time, when the mouth of the container is heat sealed by a liner composed of Aluminum layer, it prevents moisture from entering into the container. The present invention also relates to a container where the desiccant materials(s) is a part of the container and does not come out while dispensing the product.

### BACKGROUND AND THE PRIOR ART

Many drugs are typically bottled in an atmosphere of very low humidity to avoid absorption of moisture within the container. However, each time the bottle is opened by the consumer for removal of a portion of the contents, atmospheric air is admitted to the container. This results in an increase in humidity within the bottle and eventual deterioration of the contents. In order to maintain a moisture-free atmosphere within the bottle after it has been opened, packagers generally place therein a pill of desiccant material or a moisture-permeable capsule containing a desiccant. However, the danger always exists that the consumer may inadvertently remove or even take the desiccant pill or capsule. Intake of such materials can result in discomfort or serious illness.

Consequently, there have been attempts for providing desiccant material in the container such that it does not come in contact with the products contained in the container.

A bottle cap having a desiccant material attached thereto in a manner, which prevents its becoming readily detached, is known in prior art. U.S. Pat. No. 2,317,882, discloses closure caps for receptacles containing dry medicinal materials. The cap includes a separate housing made of plastic or metal for receiving an absorbent or dehydrating means to protect the medicinal materials from moisture.

U.S. Pat. No. 4,545.492 discloses a device for maintaining dry conditions in vessels. The device is a cap or stopper having a hollow section to contain a drying agent, a nonporous top member having at least one pinhole therein and a porous bottom member.

U.S. Pat. No. 6,986,807 discloses desiccant bottle cap having a desiccant material or a desiccant containing packet adhered thereto. In another embodiment of U.S. Pat. No. 6,986,807 loose desiccant material or a disk of desiccant material is sandwiched between a bottle cap liner and a porous material to create a bottle cap insert for removable insertion into a bottle cap.

One of the disadvantages of the prior art as described in the above paragraphs is that once the lid/closure is opened the desiccants can be tampered and removed which will make the container unable to maintain the dry conditions on further use. Further the containers as described in U.S. Pat. Nos. 2,317,882, 4,545,492 and 6,986,807 have no induction sealing and therefore no improved protection is found till the container is opened. It was also found that the container lids with inbuilt desiccants need to be stored in original packing needing humidity control as done for desiccants which would need extra handling measures.

In was found that in the container of U.S. Pat. No. 6,986,807, since the desiccant is adhered to the cap liner directly, it tends to adsorb moisture from the adhesive as well as the liner. It results in reduced adsorption capacity of the desiccant and may also result in cracking of the liner due to drying and eventually the desiccant may get detached from the cap. Once the desiccant gets detached, the residual adhesive may contaminate the product and result in increase in impurities in the drug substance. In case of the container as described in U.S. Pat. No. 6,986,807 with loose desiccant material or a disk of desiccant material, the loose material may tend to leak through the edges thereby contaminating the product. While capping, the liner also exerts pressure over the desiccant cake which may result in breakage of the cake. So, in either case, be it in cake form or the loose desiccant, the desiccant particles may leak through the edges when capping and uncapping is repeatedly done.

U.S. Pat. No. 6,720,054 discloses a desiccant system and a method for producing the same wherein a container is provided with a desiccant sheet that is trapped within the container and a water vapor impermeable cover for the container making a water impermeable seal thereto. The sheet may have a first substrate, and optionally, a second substrate, and desiccant particles adhered to the first substrate or trapped between the first substrate and the second substrate. A binder material may fuse the desiccant particles to one another and to the substrates. The sheet may be trapped within the bottle due to its tendency to unfurl to a flat condition, or it may be adhered to an inner surface of the bottle. It was required to design the desiccant sheets in particular manner which proved to be costly and technically cumbersome to manufacture. Quantity of desiccants could also be restricted to the size of the desiccant sheet and hence no option of increasing or decreasing the desiccant quantity.

U.S. Pat. No. 5,114,003 discloses a vial for housing hygroscopic materials such as tableted chemicals contains a desiccant canister secured to the inside at its base. The desiccant canister is punctured immediately prior to use. The vial containing hygroscopic materials is sealed with a lid that resists the entrance of water vapor into the vial. The holes are small enough to prevent the desiccant from falling out, but provided enough area to allow water vapor from the product housed in the vial or from the space inside the vial to diffuse into the desiccant. The advantage of preparing a sealed, packaged desiccant of U.S. Pat. No. 5,114,003 is that moisture levels in the ambient air are not a concern during vial storage or at any time before the desiccant canister is punctured. One of the basic problems faced in this prior art is that the desiccant canister or sachets are specially designed based on the specific products and the container diameter. Moreover, since the desiccant canister is punctured mechanically, the hole so created may give passage for fine desiccant particles to leak through when these containers are subject to handling and transportation, particularly for desiccants like silica gel. Silica gel is a naturally obtained material and is not found in any specific particle size distribution. So, for this application use of silica gel as a desiccant might be restricted.

U.S. Pat. No. 7,011,222 discloses a container insert which includes (a) a cup member having a central axis, the cup member being defined by a center base and a plurality of radiant support members, the radiant support members extending outwardly and upwardly from the center base with space there between; and, (b) a rigid stem member having a first end and a second end, the stem member being connected to the cup member at the first end along the central axis and extending downwardly there from away from the radiant support members. The cup member is provided with desiccant material and being present above the level of the medicine (powder, gel, capsule, etc. area) in the container, it maintains the desiccant above the contents to be kept dried. It was found that the containers of this prior art have a difficult dispensing system since the desiccant has to be removed first along with the container insert and then the product. Every time the product is dispensed, the insert cup member needs to be replaced through a cumbersome process.

JP 2005263227 discloses a food packaging container comprising a lidded main container that contains food and a flanged desiccant container that is filled with a desiccant fitted securely on the bottom of the main container such that it can be separated by simple work by removing the desiccant container from the main container easily and certainly. Accordingly the flanged desiccant container fitted at the bottom of the main container is not as integrated part to the main container in JP 2005263227. The flanged part between the desiccant container and the main container in JP 2005263227, may allow gases and moisture vapor to permeate through. The ingress of moisture through the flanged part causes the desiccant to get saturated faster and does not provide adequate moisture protection to the product for a long term. There is also a possibility of getting two pieces separated out due to mechanical hazards in transit in case of flanged desiccant container. Further if the desiccant container gets separated out, the product will be exposed to the atmosphere and stability of the product may be severely affected.

JP 6227905 teaches foamable agrochemical tablet being placed in a plastic container together with a desiccant at the bottom of the container separated with a partition plate. But the container in JP 6227905 has a diaphragm to separate out desiccants from the main container to contain the product. While in case of the present invention, the separator is a two part snap fit, injection molded plastics disc having holes in it. The separator in the present invention is placed through a locking mechanism, which does not allow it to move from its own position once fitted. Further the product in JP 6227905 first has to be packed in a foil-based bag and then into the container, and the mouth of the container in JP 6227905 is sealed by aluminum foil based sheet.

### OBJECT OF THE INVENTION

A basic object of the present invention is to overcome the disadvantages of the prior art.

It is an object of the invention to provide a container comprising an integrated chamber containing desiccant material(s) having better moisture protection to the product for a long period of time.

It is another object of the invention to provide a container comprising a separator means not allowing the contents of the container to come in contact with the desiccant material(s).

It is another object of the invention that any existing desiccant materials available in the industry can be used which does not require reshaping or modification

It is another object of the invention to provide a container where there is no need to fill back the desiccant during usage since it does not come out.

It is therefore an object of the invention to have a device which effectively and efficiently removes moisture from the atmosphere of containers which at the same time prevents moisture from entering into the container when the mouth of the container is heat sealed by a liner composed of Aluminum layer

### SUMMARY OF THE INVENTION

According to one aspect of the present invention there is provided a container for storing tablets and/or capsules, said container comprising:

an upper portion and a bottom portion wherein said bottom portion defines an integrated chamber adapted to store desiccant material;

rib profile being provided on the inside surface of said container having a predetermined curvature;

a separator means being provided inside the container separating said upper portion and said bottom portion;

wherein said separator means being snap-locked in the said rib profile,

wherein said separator means comprises perforated disc means having at least two substantially parallel perforated surfaces being joined to each other by a circumferential surface such that said two perforated surfaces having a predetermined appropriate clearance between them so that there is no possibility of products of said container coming in contact with said desiccant materials.

### DETAILED DESCRIPTION OF THE INVENTION

The present invention provides a container for storing tablets and/or capsules. The container of the present invention has an integrated chamber for containing desiccant materials which would take care of moisture entering into the container while opening of the container. In the description below different components of the container has been described. It is to be understood that the components/parts used in the present invention can be replaced by their technical equivalence and still the invention can be performed and therefore non of the components/parts of the container should be considered as a restriction.

The container comprises an upper portion and a bottom portion defining an integrated chamber for storing desiccant material. The inside surface of the container is provided with a rib profile of predetermined curvature. The container further comprises a separator means snap-locked in the rib profile separating the upper portion and the bottom portion. The separator means comprises perforated disc means having at least two substantially parallel perforated surfaces joined to each other by a circumferential surface. Such design provides appropriate clearance between the perforated surfaces so that there is no possibility of products of said container coming in contact with the desiccant materials.

One embodiment of the present invention describes the desiccant materials provided in the integrated chamber is in the form of a Sachet, Canister or Compressed and Polymer Coated Solid Form known as CSF.

The shape of the separator means depends on the shape of the container. The present embodiment describes the container having cylindrical/circular shape. However, such shape of the container is not supposed to be considered as any restriction of the present invention. The shape of the other parts/components will vary with the shape of the container so as to match with the container ergonomics. The separator means may be made of HDPE, PP or any other thermoplastic polymer or co-polymer that can be injection moulded. The separator means is press-fitted in the rib profile provided in the container of the present invention. Such type of press-fit engagement of the separator means and the container ribs provides appropriate snap locking to the separator means such that in use the separator cannot be easily dismantled from the container.

The container of the present invention can be closed by using any plastic closure which may be Child Resistant or normal Screw Cap, either waded or non-waded. The closure can also be provided with a wad with aluminum foil capable of providing induction sealing which would eliminate ingress of moisture into the container. The closure of the desiccant container of the present invention can have varied closure liners depending on the product which is to be stored in the container.

The container according to the present invention may have wide mouth of any shape and size and may be made of High Density Polyethylene (HDPE), Polypropylene (PP) or any other thermoplastic polymer or co-polymer which can be blow moulded.

The size of this container can be as small as 20 ml and as big as 100 liter, practically any size that is feasible for manufacturing by blow moulding process for the container and the injection moulding process for the separator.

Quantity of desiccant provided in the container depends on the size of the container and the product being packed.

### BRIEF DESCRIPTION OF THE ACCOMPANYING DRAWINGS

FIG. 1(a) illustrates the longitudinal cross-sectional view desiccant container of the present invention.

FIG. 1(b) illustrates the longitudinal view desiccant container of the present invention.

FIG. 1(c) illustrates the cross-sectional view desiccant container of the present invention.

FIG. 2(a) illustrates the side view of the separator means of the desiccant container of the present invention.

FIG. 2(b) illustrates the top view of the separator means of the desiccant container of the present invention

### DETAILED DESCRIPTION OF THE ACCOMPANYING DRAWINGS

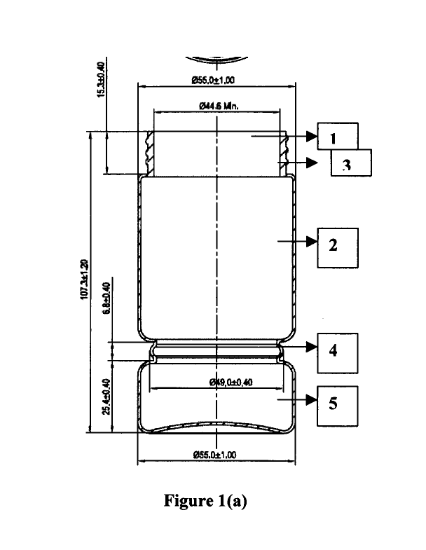

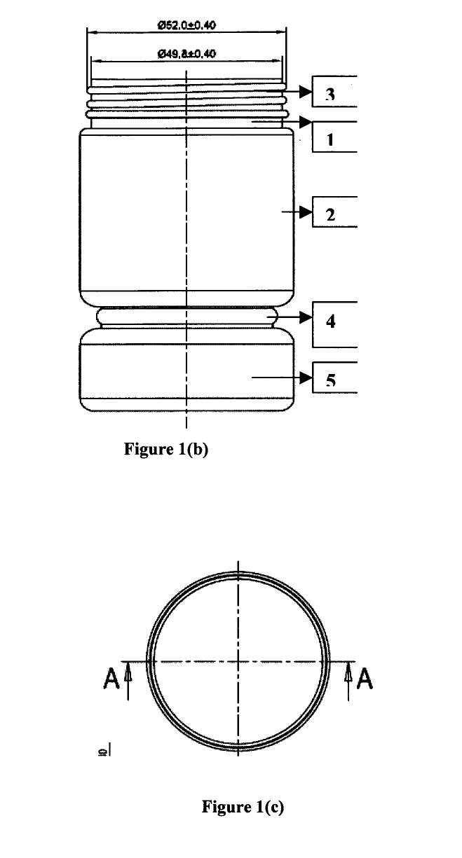

FIG. 1(a) shows the longitudinal cross-sectional view of the desiccant container of the present invention. The container is cylindrical in shape. The neck (1) of the container has diameter less than that of the container body and has threads (3) on its outer circumferential body. The container has two portions, the upper portion (2) which stores the products while bottom portion (5) stores the desiccant material. In between the two portions (2) and (5) of the container, there is a region of constriction (4) where the diameter is less than the rest of the container. This constricted region comprises of the rib profile of the present invention which secures the separator means of the present invention. The separator means has diameter comparable to that of the constricted region in the container.

FIG. 1(b) shows the longitudinal view of the desiccant container with neck (1), thread (3), upper portion (2), constricted rib region (4) and bottom portion (5).

FIG. 1(c) shows the cross-sectional view desiccant container of the present invention.

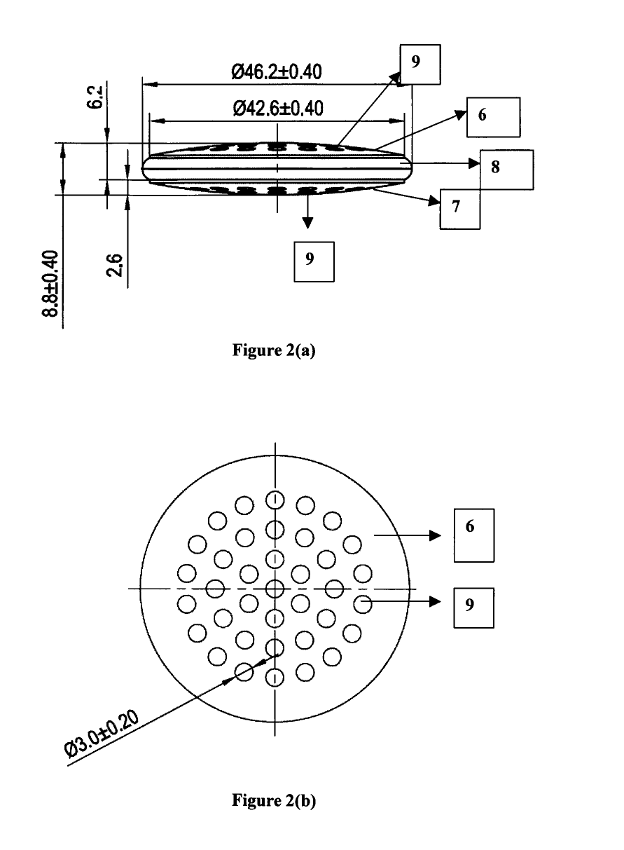

FIG. 2(a) illustrates the side view of the separator means of the desiccant container of the present invention. The separator means is formed of two perforated disc (6) and (7) with a gap in between the two discs and a circumferential surface (8) which joins surface (6) and (7). The two perforated discs comprise of plurality of perforations (9).

FIG. 2(b) shows the top view of the perforated disc, of the separator means of the container of the present invention, which comprises of plurality of perforations (9).

### ADVANTAGES

The desiccant container of the present invention has the advantage for providing seal to the mouth of the container using aluminum foil based liner, thereby providing superior protection from moisture.

The desiccant container of the present invention negates the use of additional means for tamper evidence by providing an induction heat seal on the mouth of the container which provides tamper evidence.

Further the containers of the present invention have the advantage of being used on existing packing line with very little adjustments.

Another advantage of the present invention resides in the freedom to use various combination of different types of desiccant materials, oxygen absorbers in any form such as sachet, canister, CSF—Coated Solid Form that belong to the existing packaging inventory.

When desiccants are used in conventional packaging format in direct contact with the product, there may be ink transfer from the printed surface of the desiccant sachet and canisters to the product. The desiccant container of the present invention obviates the possibility of ink transfer from the printed surface of the desiccant sachet to the product owing to the separator means of the present invention provided between the product and the desiccants.

Another advantage of the present invention relates to a container where the desiccant materials(s) is a part of the container and does not come out thus reducing the risk of intake of desiccant pills, sachets or canisters by consumers.

1. A container for storing tablets and/or capsules, said container comprising:
an upper portion and a bottom portion wherein said bottom portion defines an integrated chamber adapted to store desiccant material;
rib profile being provided on the inside surface of said container having a predetermined curvature;
a separator means being provided inside the container separating said upper portion and said bottom portion;
wherein said separator means being snap-locked in the said rib profile,
wherein said separator means comprises perforated disc means having at least two substantially parallel perforated surfaces being joined to each other by a circumferential surface such that said two perforated surfaces having a predetermined appropriate clearance between them so that there is no possibility of products of said container coming in contact with said desiccant materials.

2. The container as claimed in claim 1, wherein said desiccant material is in the form selected from sachet, canister and coated solid form (CSF).

3. The container as claimed in claim 1, further comprising closure cap.

4. The container as claimed in claim 3 wherein said closure cap is a waded screw cap.

5. The container as claimed in claim 3 wherein said closure cap is optionally waded with a liner composed of aluminum foil.

6. The container as claimed in claim 3 wherein the said closure cap is optionally child resistant closure cap.

7. The container as claimed in claim 6 wherein said child resistant closure cap is a waded child resistant closure cap.

8. The container as claimed in claim 6 wherein said child resistant closure cap is optionally waded with a liner composed of aluminum foil.

9. (canceled)
